(19) United States
(12) Patent Application Publication
(10) Pub. No.: US 2015/0132667 A1
(43) Pub. Date: May 14, 2015

(54) Secondary Battery

(71) Applicants: MURATA MANUFACTURING CO., LTD., Nagaokakyo-Shi (JP); Carlit Holdings Co., Ltd., Tokyo (JP)

(72) Inventors: Masaharu Sato, Nagokakyo-shi (JP); Eiji Kokubu, Shibukawa-shi (JP); Kazumi Chiba, Tokyo (JP); Toshiyuki Kiryu, Shibukawa-shi (JP); Hidehisa Mokudai, Wako-Shi (JP); Toru Sukigara, Wako-shi (JP)

(21) Appl. No.: 14/598,292

(22) Filed: Jan. 16, 2015

Related U.S. Application Data
(63) Continuation of application No. PCT/JP13/69135, filed on Jul. 12, 2013.

(30) Foreign Application Priority Data
Jul. 18, 2012 (JP) 2012-159577

(51) Int. Cl. H01M 4/60; H01M 10/0569

(52) U.S. Cl. CPC H01M 4/604; H01M 10/0569; H01M 4/608; H01M 4/60; H01M 2220/30
USPC 429/340

(57) ABSTRACT

A secondary battery having an electrode active material mainly composed of an organic compound that includes, in a constituent unit, at least one compound selected from the group consisting of a dithione compound having a dithione structure, a dione compound having a dione structure, an organic radical compound containing a stable radical group and a diamine compound having a diamine structure. The secondary battery also has an electrolyte that contains a chain sulfone compound.

### CROSS REFERENCE TO RELATED APPLICATIONS

This application is a continuation application of international patent application Serial No. PCT/JP2013/069135 filed 12 Jul. 2013, which published as PCT Publication No. WO2014/013948 on 23 Jan. 2014, which claims benefit of Japan patent application No. 2012-159577 filed 18 Jul. 2012, the entire content of which are incorporated herein by reference.

### TECHNICAL FIELD

The present invention relates to a secondary battery, and more particularly relates to a secondary battery containing an electrode active material and an electrolyte and undergoing repeated charging and discharging by using an electrode reaction in the battery.

### BACKGROUND ART

With the market expansion of mobile electronic devices such as cellular phones, laptop personal computers and digital cameras, a long-life secondary battery having high energy density is desired as a cordless power source of these electronic devices.

To respond to such requirements, secondary batteries which use alkali metal ions such as lithium ions as a charge carrier, and use an electrochemical reaction associated with giving and receiving of charges of the charge carrier, have been developed. Particularly, a lithium ion secondary battery having high energy density currently becomes widely available.

An electrode active material of structural elements of the secondary battery is a substance directly contributing to electrode reactions of charging and discharging in the battery, and has a central role in the secondary battery. That is, the electrode reaction in the battery is a reaction which occurs associated with giving and receiving of electrons by applying a voltage to an electrode active material electrically connected to an electrode located in an electrolyte, and the electrode reaction progresses during charge and discharge of the battery. Accordingly, as described above, the electrode active material systemically has a central role in the secondary battery.

In the lithium ion secondary battery, a lithium-containing transition metal oxide is used as a positive electrode active material and a carbon material is used as a negative electrode active material, and charge and discharge is performed by using a lithium ion insertion and detachment reactions for these electrode active materials.

However, the lithium ion secondary battery has a problem that a charge-discharge rate is restricted since the movement of lithium ions in the positive electrode becomes rate-determining. That is, since the moving rate of lithium ions in the transition metal oxide of the positive electrode in the lithium ion secondary battery is slow as compared with the electrolyte or the negative electrode, the electrode reaction rate in the positive electrode becomes rate-determining to restrict a charge-discharge rate, and consequently there are limitations to an increase in output or shorten of charging time.

Thus, in recent years, organic secondary batteries using an organic compound such as an organic sulfur compound for the electrode active material are actively researched and developed in order to solve these problems.

For example, the document 1 proposes a novel metal-sulfur type battery in which the organic sulfur compound as a positive electrode material has an S—S bond in a charged state, the S—S bond is cleaved during discharge of the positive electrode to form an organic sulfur metal salt having metal ions.

In the document 1, a disulfide-based organic compound (hereinafter, referred to as a “disulfide compound”) represented by the general formula (1′) is used for the positive electrode active material.

R—S—S—R (1′)

R indicates aliphatic organic groups or aromatic organic groups, and the aliphatic organic groups or the aromatic organic groups may be the same or different from each other.

In the disulfide compound, a two-electron reaction can occur, and an S—S bond of the compound is cleaved in a reduced state (discharged state), and thereby organic thiolate (R—SH) is formed. The organic thiolate forms an S—S bond in an oxidized state (charged state), and returns back to the disulfide compound indicated by the general formula (1′). That is, since the disulfide compound forms the S—S bond having small bond energy, a reversible oxidation-reduction reaction occurs with the use of bonding and cleavage by the reaction, and thereby charge and discharge can be performed.

Further, the document 2 proposes an electrode for a battery which has a structural unit indicated by the following formula (2′):

—(NH—CS—CS—NH) (2′)

and includes rubeanic acid or rubeanic acid polymer capable of being bonded with lithium ions.

The rubeanic acid or rubeanic acid polymer containing a dithione structure indicated by the general formula (2′) is bonded with lithium ions during reduction, and releases the bonded lithium ions during oxidation. It is possible to perform charge and discharge by using such a reversible oxidation-reduction reaction of rubeanic acid or rubeanic acid polymer.

On the other hand, the electrode active material of the secondary battery varies significantly in volume according to chemical changes associated with the charge-discharge reaction, and consequently, the electrode active material in a solid state may be destroyed or dissolved in the electrolyte so that it does not function as the electrode active material. Particularly, in the organic secondary battery which performs charging and discharging by using an oxidation-reduction reaction of a molecule itself in contrast to a lithium ion battery which performs charging and discharging in a state of maintaining a crystal system, it is thought that the electrode active material is easily dissolved in the electrolyte, and therefore the suppression of such dissolution of the electrode active material in the electrolyte is investigated.

Then, for example, the document 3 proposes a battery including a negative electrode, a solid composite positive electrode having an electrically active sulfur-containing substance, and an electrolyte interposed therebetween.

The document 3 describes, as a preferred embodiment of an electrolyte, a mixture of at least one ionic electrolyte salt and at least one electrolyte solvent selected from N-methylacetamide, acetonitrile, carbonate, sulfolane, sulfone, N-alkyl pyrrolidone, dioxolane, aliphatic ether, cyclic ether, glyme and siloxane. 1,3-dioxolane is used as the electrolyte solvent and dimethoxy ethane is used as the ionic electrolyte salt to prepare an electrolyte, and then a battery, in which a positive electrode material contains an electrically active sulfur-containing substance, is prepared.

Document 1: U.S. Pat. No. 4,833,048 (claim 1, fifth column lines 20-28)

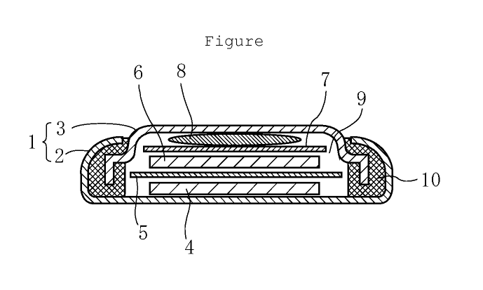

Document 2: JP No. 2008-147015A (claim 1, par. {0011}, FIGS. 3 and 5)

Document 3: JP No. 2002-532854A (claim 1, claim 83, pars. {0031}, {0088} etc.)

### SUMMARY OF THE INVENTION

In the document 1, although a low molecular disulfide compound involving two electrons is used, since bonding with other molecules and cleavage are repeated in association with the charge-discharge reaction, the battery lacks stability and has a possibility that repeated charge and discharge causes a capacity to deteriorate.

In the document 2, although the two-electron reaction is initiated by using the rubeanic acid having a dithione structure, when a low molecular weight compound such as the rubeanic acid is used, dissolution in an electrolyte solution or contamination of the electrode due to a dissolved compound easily occurs, and therefore the battery lacks the stability for repeated charge and discharge. Further, when a polymer compound such as a rubeanic acid polymer is used, dissolution in an electrolyte solution or contamination of the electrode can be suppressed; however, intermolecular interaction within the rubeanic acid polymer is large. For this reason, the movement of ions is interfered, and a ratio of the active material which can be used effectively is small.

In the document 3, although a sulfur-based compound is used for the positive electrode active material and an electrolyte having oxolane or the like used as the solvent is prepared to thereby form a battery, it is in a difficult situation to attain a secondary battery having stable and excellent cycle characteristics even though using such an electrolyte.

As described above, although a secondary battery indicated in the prior arts is prepared by combined use of an organic compound and an electrolyte, it is not yet possible to realize a long-life secondary battery having adequately high energy density, high output, and excellent cycle characteristics.

The present invention has been made in view of such a situation, and it is an object of the present invention to provide a secondary battery having high energy density, high output, and excellent cycle characteristics in which the deterioration of capacity is suppressed even if charge and discharge are repeated.

The present inventors have made studies by using an organic compound capable of obtaining an electrode active material having high charge-discharge efficiency and a high capacity density, which organic compound has a dithione structure, a dione structure, astable radical group and a diamine structure in its structural unit, and consequently have found that when an electrolyte containing a chain sulfone compound is used, the above-mentioned organic compound is stabilized in the electrolyte and a charge-discharge reaction can be stably repeated. That is, it is found that the movement of ions during the charge-discharge reaction becomes easy for the organic compound by using the electrolyte containing a chain sulfone compound, and the charge-discharge reaction proceeds smoothly, and therefore charging in a short time and discharging at high output can be stably performed.

The present invention has been made based on the above findings, and a secondary battery according to the present invention is a secondary battery comprising an electrode active material and an electrolyte, and repeating charging and discharging by an electrode reaction in the battery of the electrode active material, wherein the electrode active material has, as the main component thereof, an organic compound containing, in its structural unit, at least one compound selected from the group consisting of a dithione compound having a dithione structure, a dione compound having a dione structure, an organic radical compound containing a stable radical group, and a diamine compound having a diamine structure, and the electrolyte contains a chain sulfone compound.

Further, in the secondary battery of the present invention, the chain sulfone compound is preferably represented by the general formula:

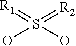

In the formula, R₁ and R₂ contain at least one selected from the group consisting of a linear alkyl group and a branched alkyl group respectively having 1 to 5 carbon atoms.

Further, in the secondary battery of the present invention, the dithione compound is preferably represented by the general formula:

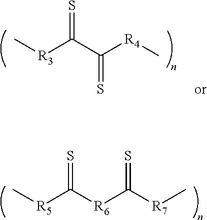

In the formula, n is an integer of 1 or more, R₃ to R₅ and R₇ indicate any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₃ to R₅ and R₇ may be the same and may be linked together to form a saturated or unsaturated ring. Further, R₆ indicates at least one of a substituted or unsubstituted alkylene group and a substituted or unsubstituted arylene group.

Further, in the secondary battery of the present invention, the dione compound is preferably represented by the general formula:

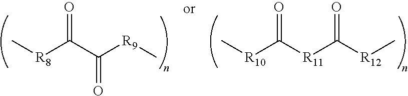

In the formula, n is an integer of 1 or more, R₈ to R₁₀ and R₁₂ indicate any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₈ to R₁₀ and R₁₂ may be the same and may be linked together to forma saturated or unsaturated ring. Further, R₁₁ indicates at least one of a substituted or unsubstituted alkylene group and a substituted or unsubstituted arylene group.

Further, in the secondary battery of the present invention, the organic radical compound is also preferably a nitroxyl radical-based compound.

Moreover, in the secondary battery of the present invention, the nitroxyl radical-based compound more preferably contains 2,2,6,6-tetramethylpiperidine-N-oxyl radical in its molecular structure.

Further, in the secondary battery of the present invention, the diamine compound is preferably represented by the general formula:

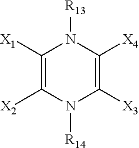

In the formula, R₁₃ and R₁₄ indicate any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof. X₁ to X₄ indicate at least one selected from the group consisting of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group, and a substituted or unsubstituted acyloxy group, and these substituents may form a cyclic structure therebetween.

Further, in the secondary battery of the present invention, the electrode active material is contained in any one of a reaction starting material, a reaction product and an intermediate product in at least a discharge reaction of the electrode reaction in the battery.

Moreover, it is preferred that the secondary battery of the present invention has a positive electrode and a negative electrode, and the positive electrode active material comprises the electrode active material as the main component thereof.

According to the secondary battery of the present invention, since the electrode active material has, as the main component thereof, an organic compound containing, in its structural unit, at least one compound selected from the group consisting of a dithione compound having a dithione structure, a dione compound having a dione structure, an organic radical compound containing a stable radical group, and a diamine compound having a conjugated diamine structure, and the electrolyte contains a chain sulfone compound, the organic compound is stabilized in the electrolyte and a charge-discharge reaction can be stably repeated. That is, since the movement of ions during the charge-discharge reaction becomes easy and a smooth and stable charge-discharge reaction occurs, it is possible to perform charging in a short time and discharging at high output, and thereby, it is possible to attain a secondary battery which has high energy density and a long cycle-life.

Furthermore, since the electrode active material contains the organic compound as the main component, an environmental burden is low and the safety is taken into consideration.

The above and other objects, features, and advantages of the invention will become more apparent from the following description.

### BRIEF DESCRIPTION OF THE DRAWING

The FIGURE is a sectional view showing an embodiment of a coin type battery as a secondary battery according to the present invention.

### DETAILED DESCRIPTION OF THE PREFERRED EMBODIMENTS

An embodiment of the present invention will be described in detail.

The FIGURE is a sectional view showing a coin type battery as an embodiment of a secondary battery according to the present invention.

A battery can 1 has a positive electrode case 2 and a negative electrode case 3, and the positive electrode case 2 and the negative electrode case 3 are both formed into the shape of a disc-shaped thin plate. A positive electrode 4, which is obtained by forming electrode active material into a sheet shape, is arranged at a bottom center of the positive electrode case 2 constituting a positive electrode current collector. Further, a separator 5 formed of a porous film such as polypropylene is laminated on the positive electrode 4, and a negative electrode 6 is laminated on the separator 5. As a material of the negative electrode 6, for example, copper having a lithium metal foil overlaid thereon, and the metal foil having a lithium absorption material such as graphite or hard carbon applied thereto can be used. A negative electrode current collector 7 formed of Cu or the like is laminated on the negative electrode 6, and a metallic spring 8 is placed on the negative electrode current collector 7. Further, an electrolyte solution 9 is filled into an internal space, and the negative electrode case 3 is attached fixedly to the positive electrode case 2 against a biasing force of the metallic spring 8, and these cases are sealed with a gasket 10 interposed therebetween.

Further, in the secondary battery, the electrode active material has, as the main component thereof, an organic compound containing a specific structure in the structural unit thereof. Specifically, the organic compound contains, in its structural unit, at least one compound selected from a dithione compound having a dithione structure, a dione compound having a dione structure, an organic radical compound containing a stable radical group, and a diamine compound having a diamine structure.

The electrolyte solution 9 contains an electrolyte salt and a solvent in which the electrolyte salt is dissolved, and the solvent contains a chain sulfone compound. That is, the electrolyte solution 9 is interposed between the positive electrode 4 and the negative electrode 6, an opposed electrode of the positive electrode 4, to perform charge carrier transport between both electrodes; however, in the present embodiment, the electrolyte salt is used in a state of being dissolved in or being compatible with the solvent containing the chain sulfone compound. Thereby, the movement of ions during the charge-discharge reaction becomes easy and it is possible to initiate a smooth and stable charge-discharge reaction. As a result, it is possible to perform charging in a short time and discharging at high output, and thereby, it is possible to realize a secondary battery having a long-life electrode active material and having high energy density.

That is, in recent years, the electrode active materials containing the organic compound as the main component receive attention, and particularly, the above-mentioned dithione compound, dione compound, organic radical compound and diamine compound are promising materials for an active material capable of realizing high charge-discharge efficiency and a high capacity density.

However, in these organic compounds, when a low molecular weight compound is used, dissolution in the electrolyte solution 9 or contamination of the electrode due to a dissolved compound easily occurs, and thereby, the battery lacks the stability for repeated charge and discharge. On the other hand, when a polymer compound is used, intramolecular interactions within the polymer compound is large, and thereby, the movement of ions is interfered and there is a fear that a ratio of the active material which can be used effectively is decreased.

Then, the present inventors have made studies, and it is found that by using the electrolyte solution 9 containing a chain sulfone compound in a solvent, the positive electrode active material containing the organic compound as the main component is stabilized, and consequently the movement of ions during the charge-discharge reaction becomes easy, and the charge-discharge reaction proceeds smoothly, and therefore charging in a short time and discharging at high output can be stably performed.

Thus, in the present embodiment, it is adapted to attain a secondary battery, by containing a chain sulfone compound in the solvent of the electrolyte solution 9, having high energy density, high output and a long cycle-life in which the deterioration of capacity is suppressed even if charge and discharge are repeated.

A compound species of such a chain sulfone compound is not particularly limited; however, a compound represented by the general formula (1) can be preferably used.

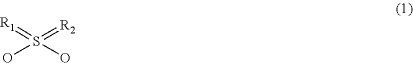

In the formula (1), R₁ and R₂ contain at least one selected from the group consisting of a linear alkyl group and a branched alkyl group respectively having 1 to 5 carbon atoms. The chain sulfone compounds having 6 or more carbon atoms are not preferred since they have a long chain structure to be high in viscosity. Cyclic sulfone compounds such as sulfolane are not also preferred since the cyclic sulfone compound alone has a high freezing point and the electrolyte salt is hardly dissolved therein.

Examples of the chain sulfone compounds falling within the category of the compounds represented by the chemical formula (1) may include dimethyl sulfone indicated by the following chemical formula (1a), ethyl methyl sulfone indicated by the following chemical formula (1b), methyl isopropyl sulfone indicated by the following chemical formula (1c), ethyl isopropyl sulfone indicated by the following chemical formula (1d) and ethyl isobutyl sulfone indicated by the following chemical formula (1e).

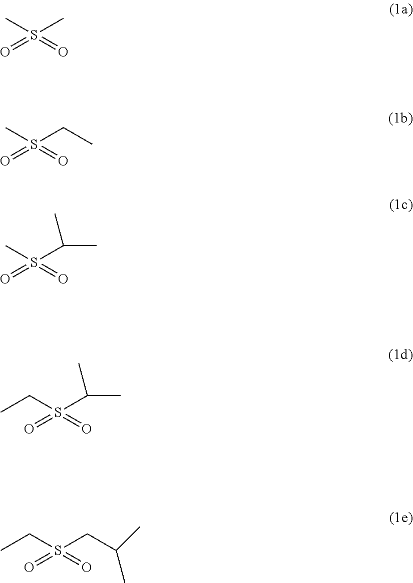

The content of the chain sulfone compound in the electrolyte solution 9 is not particularly limited; however, the content in the solvent is preferably 50% by mass or more in order to exert a desired effect. Further, two or more kinds of the chain sulfone compounds indicated by the above chemical formulas (1a) to (1e) or the like may be combined, or a compound other than the chain sulfone compound may be contained as an additive.

The electrolyte salt contained in the electrolyte solution 9 is not particularly limited, and for example, LiPF₆, LiClO₄, LiBF₄, LiCF₃SO₃, Li(CF₃SO₂)₂, LiN(C₂F₅SO₂)₂, LiC(CF₃SO₂)₃, LiC(C₂F₅SO₂)₃ and the like can be used.

Next, the above-mentioned organic compound mainly constituting the positive electrode active material will be described in detail.

(1) Dithione Compound

In a dithione compound, the stability during charging and discharging (an oxidized state and a reduced state) is excellent, and multi-electron reaction of two-electrons or more can occur in the oxidation-reduction reaction. Accordingly, when the dithione compound is used for the positive electrode active material and the chain sulfone compound is contained in the electrolyte solution 9, the dithione compound serving as a positive electrode active material is stabilized in the electrolyte solution 9, and therefore charge and discharge of a multi-electron reaction can be stably repeated, and it is possible to obtain a secondary battery having high charge-discharge efficiency and a high capacity density.

Such a dithione compound is not particularly limited as long as it has a dithione structure in its structural unit, and a compound represented by the following general formula (2) or (3) can be preferably used.

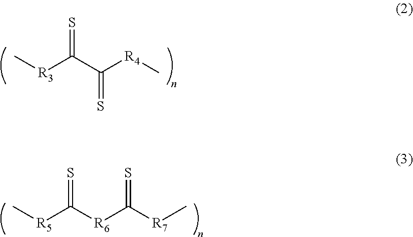

In the formulas (2) and (3), n is an integer of 1 or more, R₃ to R₅ and R₇ indicate any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₃ to R₅ and R₇ may be the same and may be linked together to form a saturated or unsaturated ring. Further, R₆ indicates at least one of a substituted or unsubstituted alkylene group and a substituted or unsubstituted arylene group.

Examples of dithione compounds falling within the category of the compounds indicated by the above chemical formula (2) may include organic compounds indicated by the following chemical formulas (2a) to (2i).

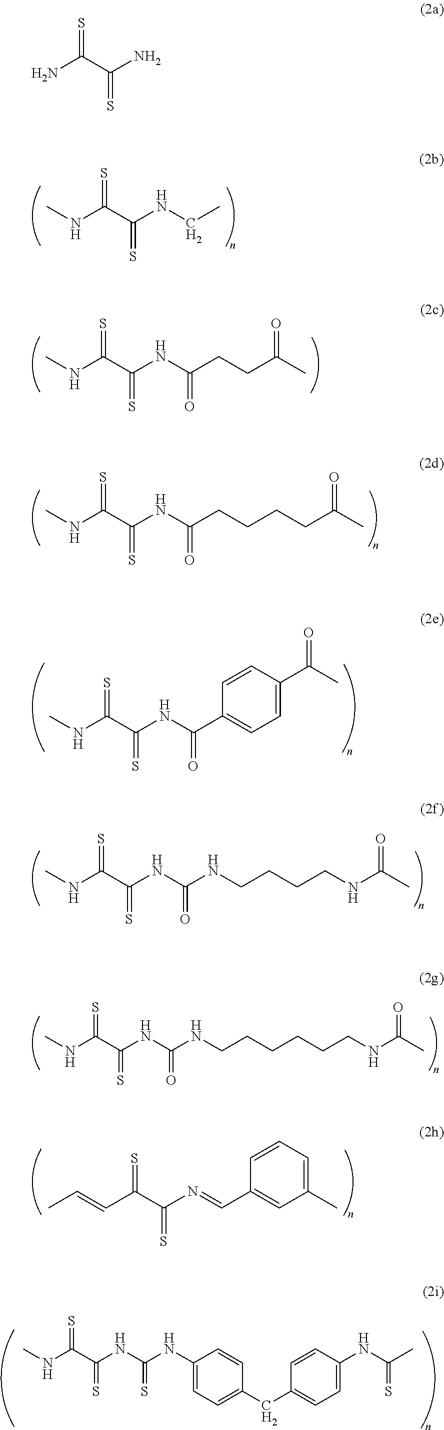

The following chemical reaction formula (I) shows an example of the charge-discharge reaction which is predicted when the dithione compound indicated by the chemical formula (2a) is used for the positive electrode active material and Li is used for a cation of the electrolyte salt.

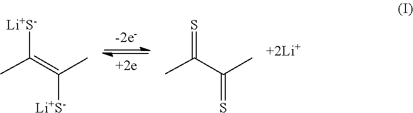

Further, examples of dithione compounds falling within the category of the compounds indicated by the chemical formula (3) may include organic compounds indicated by the following chemical formulas (3a) to (3g).

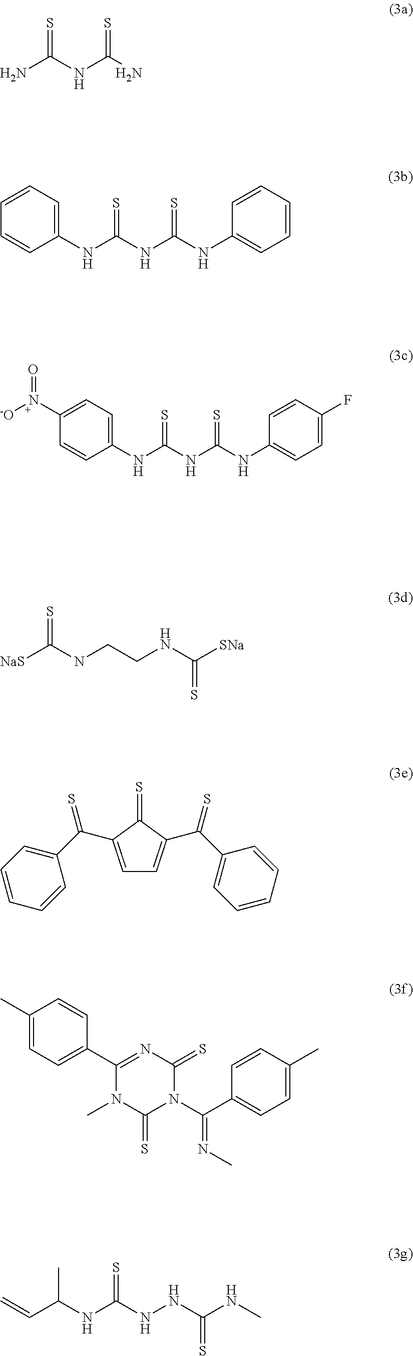

Further, the following chemical reaction formula (II) shows an example of the charge-discharge reaction which is predicted when the dithione compound indicated by the chemical formula (3a) is used for the positive electrode active material

and Li is used for a cation of the electrolyte salt.

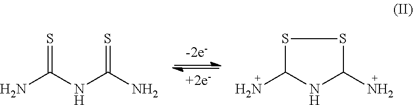 [SMILES: NC(=S)NC(N)=S ; NC1NC(N)SS1]

A molecular weight of the organic compound constituting the positive electrode active material is not particularly limited; however, if a portion other than the dithione structure is large, a molecular weight is increased and therefore an electric storage capacity per unit mass, i.e., a capacity density, is decreased. Accordingly, the molecular weight of the portion other than the dithione structure is preferably small.

(2) Dione Compound

In the dione compound, as with the dithione compound, the stability during charging and discharging (an oxidized state and a reduced state) is excellent, and multi-electron reaction of two-electrons or more can occur in the oxidation-reduction reaction. Accordingly, when the dione compound is used for the positive electrode active material and the chain sulfone compound is contained in the electrolyte solution 9, the dione compound serving as a positive electrode active material is stabilized in the electrolyte solution 9, and therefore charge and discharge of a multi-electron reaction can be stably repeated, and it is possible to obtain a secondary battery having high charge-discharge efficiency and a high capacity density.

Such a dione compound is not particularly limited as long as it has a dione structure in its structural unit, and a compound indicated by the following general formula (4) or (5) can be preferably used.

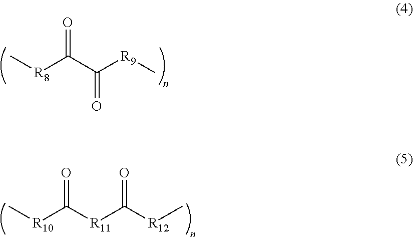

In the above (4) and (5), n is an integer of 1 or more, R₈ to R₁₀ and R₁₂ indicate any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₈ to R₁₀ and R₁₂ may be the same and may be linked together to forma saturated or unsaturated ring. Further, R₁₁ indicates at least one of a substituted or unsubstituted alkylene group and a substituted or unsubstituted arylene group.

Examples of dione compounds falling within the category of the compounds indicated by the chemical formula (4) may include organic compounds indicated by the following chemical formulas (4a) to (4e).

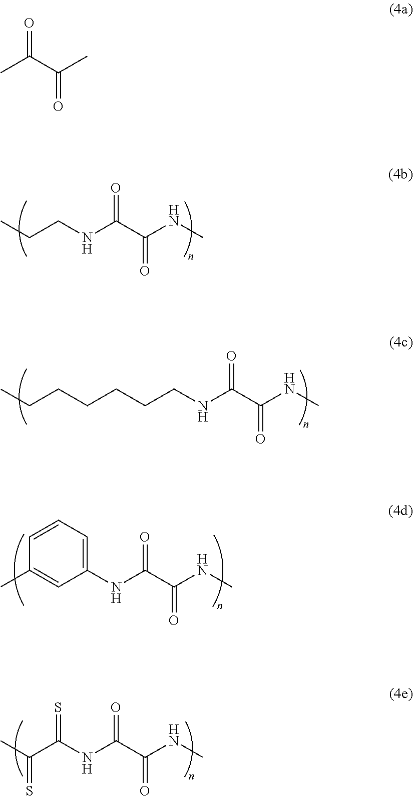

The following chemical reaction formula (III) shows an example of the charge-discharge reaction which is predicted when the dione compound represented by the chemical formula (4a) is used for the positive electrode active material and Li is used for a cation of the electrolyte salt.

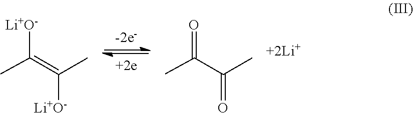

Further, examples of dione compounds falling within the category of the compounds indicated by the above chemical formula (5) may include organic compounds indicated by the following chemical formulas (5a) to (5d).

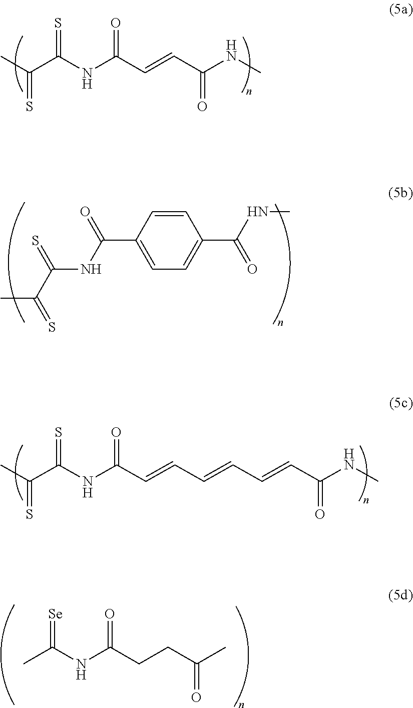

The following chemical reaction formula (IV) shows an example of the charge-discharge reaction which is predicted when the dione compound indicated by the chemical formula (5a) is used for the positive electrode active material and Li is used for a cation of the electrolyte salt.

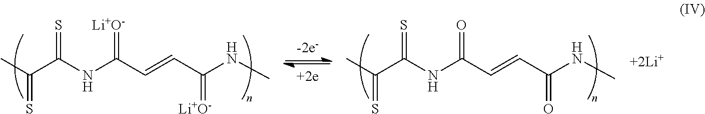

A molecular weight of the organic compound constituting the positive electrode active material is not particularly limited; however, if a portion other than the dione structure is large, a molecular weight is increased and therefore an electric storage capacity per unit mass, i.e. a capacity density, is decreased. Accordingly, the molecular weight of the portion other than the dione structure is preferably small.

(3) Organic Radical Compound

The organic radical compound containing a stable radical group can accelerate proceeding of the charge-discharge reaction.

The organic radical compound has radicals in which unpaired electrons exist at an outer most shell of an electron orbital. The radicals are generally a chemical species rich in reactivity, and many of them disappear after a certain level of life by the interaction with surrounding substances; however, the radicals are stabilized depending on a state of resonance effect, steric hindrance or solvation, and become stable radicals existing stably for a long time. Further, since radicals have a large reaction rate, charge and discharge can be performed with the use of an oxidation-reduction reaction of stable radicals.

The organic radical compound can increase the reaction site concentration because unpaired electrons to be reacted exist locally in radical atoms, and thereby, a secondary battery having high capacity can be realized.

Accordingly, when the organic radical compound is used for the positive electrode active material and the chain sulfone compound is contained in the electrolyte solution 9, the organic radical compound serving as a positive electrode active material is stabilized in the electrolyte solution 9 to facilitate the movement of ions in a charge and discharge reaction, and therefore the charge-discharge reaction proceeds smoothly and it is possible to perform charging in a short time and discharging at high output.

As the stable radical group contained in such an organic radical compound, a nitroxyl radical group, a nitrogen radical group, an oxygen radical group, a thioaminyl radical group, a sulfur radical group, a boron radical group or the like can be used; however, a nitroxyl radical group represented by the general formula (6) is preferably used.

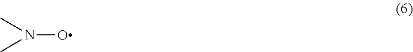

The following chemical reaction formula (V) shows an example of the charge-discharge reaction which is predicted when a nitroxyl radical compound containing the nitroxyl radical group is used for the electrode active material and Li is used for a cation of the electrolyte salt.

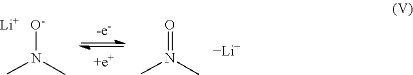

Further, among the nitroxyl-based radical compounds, a compound, which contains a 2,2,6,6-tetramethylpiperidine-N-oxyl radical structure represented by the general formula (7) in its molecular structure, is particularly preferred since the charge-discharge reaction stably proceeds.

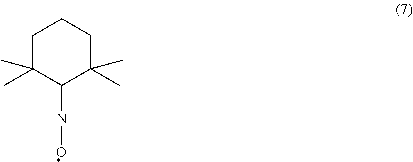

Examples of organic compounds falling within the category of the compounds indicated by the above chemical formula (7) may include organic compounds indicated by the chemical formulas (7a) to (7e), and copolymers in which these organic compounds constitute part of repeating units.

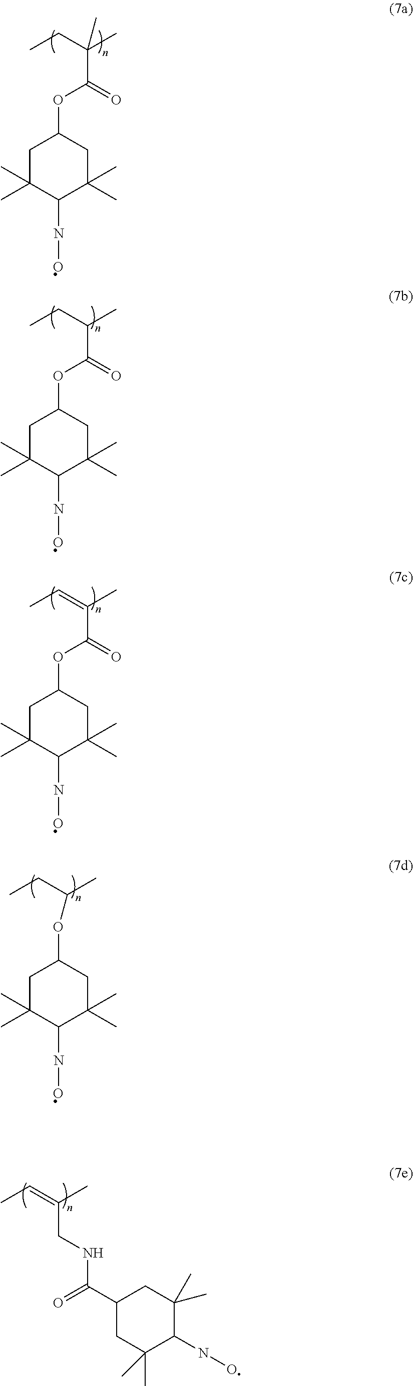

A molecular weight of the organic compound constituting the positive electrode active material is not particularly limited; however, if a portion other than a portion involving the stable radical group such as the 2,2,6,6-tetramethylpiperidine-N-oxyl radical structure is large, a molecular weight is increased and therefore an electric storage capacity per unit mass, i.e. a capacity density, is decreased. Accordingly, the molecular weight of the portion other than the portion involving the stable radical group is preferably small.

(4) Diamine Compound

In the diamine compound, as well as the dithione compound and dione compound, the stability during charging and discharging (an oxidized state and a reduced state) is excellent, and multi-electron reaction of two-electrons or more can occur in the oxidation-reduction reaction. Accordingly, when the diamine compound is used for the positive electrode active material and the chain sulfone compound is contained in the electrolyte solution 9, the diamine compound serving as a positive electrode active material is stabilized in the electrolyte solution 9, and therefore charge and discharge of a multi-electron reaction can be stably repeated, and it is possible to attain a secondary battery having high charge-discharge efficiency and a high capacity density.

Such a diamine compound is not particularly limited as long as it has a diamine structure in its structural unit, and a compound represented by the following general formula (8) can be preferably used.

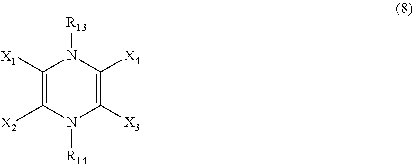

In the chemical formula (8), R₁₃ and R₁₄ indicate any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof. X₁ to X₄ indicate at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group and a substituted or unsubstituted acyloxy group, and these substituents may form a cyclic structure therebetween.

As an organic compound included in the category of the chemical formula (8), an organic compound containing, in its structural unit, a phenazine structure in which aryl groups are coupled with each other with a pyrazine ring interposed therebetween is more preferred, and for example, organic compounds indicated by chemical formulas (8a) to (8f) can be preferably used.

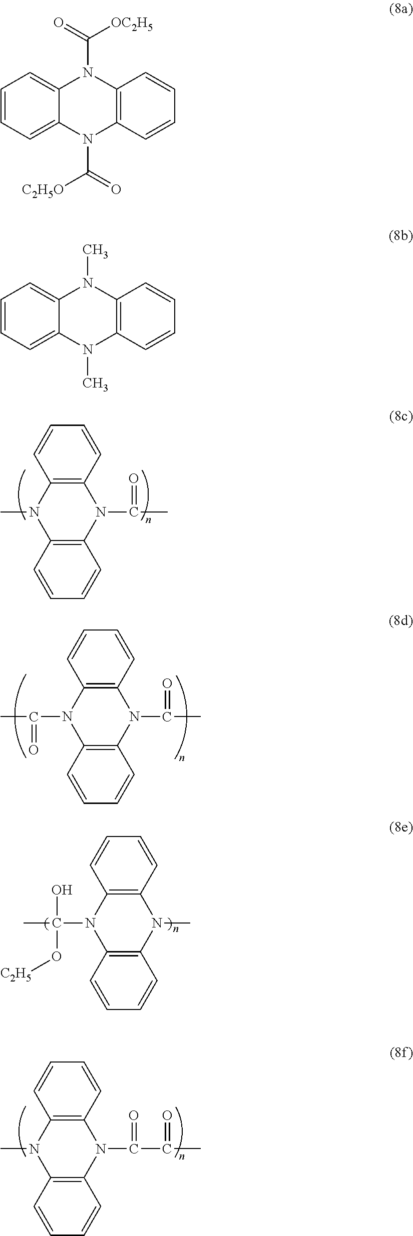

The following chemical reaction formula (VI) shows an example of the charge-discharge reaction which is predicted when the organic compound indicated by the chemical formula (8b) is used for the electrode active material and Li is used for a cation of the electrolyte salt.

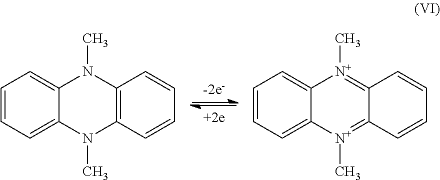 [SMILES: CN1c2ccccc2N(C)c2ccccc21 ; C[n+]1c2ccccc2[n+](C)c2ccccc21]

A molecular weight of the above-mentioned diamine compound is not particularly limited; however, if a portion other than the diamine structure is large, a molecular weight is increased and therefore an electric storage capacity per unit mass, i.e. a capacity density, is decreased. Accordingly, the molecular weight of the portion other than the diamine structure is preferably small.

The substituents indicated by the above general formulas (2) to (5) and (8) are not particularly limited as long as they falls within the respective categories; however, when the molecular weights of the substituents are increased, a charge amount capable of being stored per unit mass of the positive electrode active material is small, and therefore it is preferred to select a desired substituent such that its molecular weight is about 250.

Next, an example of a method of manufacturing the secondary battery will be described in detail.

First, an electrode active material is formed into an electrode shape. That is, any of the organic compounds described above is prepared. Then, the organic compound is mixed with a conductive agent and a binder, a solvent is then added to the resulting mixture to prepare a slurry for an active material, and the slurry for an active material is applied onto a positive electrode current collector by arbitrary coating method and dried to form a positive electrode contained a positive electrode active material 4.

The conductive agent is not particularly limited, and for example, carbonaceous fine particles such as graphite, carbon black, and acetylene black; carbon fibers such as vapor-grown carbon fibers, carbon nanotubes, and carbon nanohorns; and conductive polymers such as polyaniline, polypyrrole, polythiophene, polyacetylene, and polyacene can be used. Further, two or more kinds of the conductive agents can be mixed for use. Besides, the content of the conductive agent in the positive electrode active material is preferably 10 to 80% by weight.

Also, the binder is not particularly limited, and various resins such as polyethylene, polyvinylidene fluoride, polyhexafluoropropylene, polytetrafluoroethylene, polyethylene oxide, and carboxymethyl cellulose can be used.

Moreover, the solvent used for the slurry for an active material is not particularly limited, and for example, basic solvents such as dimethylsulfoxide, dimethylformamide, N-methylpyrrolidone, propylene carbonate, diethyl carbonate, dimethyl carbonate, and γ-butyrolactone; non-aqueous solvents such as acetonitrile, tetrahydrofuran, nitrobenzene, and acetone; and protic solvents such as methanol and ethanol can be used.

A kind of the solvents, a mixing ratio of the organic compound and the solvent, and a kind and addition amount of the conductive agent and the binder, and the like can be optionally set in consideration of required characteristics of the secondary battery, productivity and the like.

Then, the positive electrode 4 is impregnated with the electrolyte solution 9 containing the chain sulfone compound to allow the electrolyte solution 9 to penetrate into the positive electrode 4, and thereafter, the separator 5 impregnated with the electrolyte solution 9 is laminated on the positive electrode 4, and the negative electrode 6 and the negative electrode current collector 7 are laminated in turn, and thereafter, the electrolyte solution 9 is injected into an internal space. Then, the metallic spring 8 is placed on the negative electrode current collector 7, and the gasket 10 is arranged at a periphery, and the negative electrode case 3 is attached fixedly to the positive electrode case 2, and these cases are externally sealed with a caulking machine to prepare a coin type secondary battery.

Further, while the positive electrode active material has a varying structure and state depending on a charge state, a discharge state or an intermediate state thereof since the positive electrode active material is reversibly oxidized or reduced by charging and discharging, in the present embodiment, the positive electrode active material is contained in any one of a reaction starting material (a substance initiating a chemical reaction in an electrode reaction in the battery), a reaction product (a substance produced as a result of a chemical reaction), and an intermediate product in at least a discharge reaction, and thereby, it is possible to realize a secondary battery which has a positive electrode active material having high charge-discharge efficiency and a high capacity density.

According to the present embodiment, as described above, the secondary battery is configured by using the electrolyte solution 9 containing the chain sulfone compound contributing to the stabilization of the positive electrode active material and the above-mentioned positive electrode active material having good charge-discharge efficiency and a high capacity density, and therefore the movement of ions during a charge and discharge reaction becomes easy, and a smooth and stable charge-discharge reaction can be repeated. That is, it is possible to perform charging in a short time and discharging at high output, and thereby, it is possible to attain a long-life secondary battery which has high energy density, has high output, and has excellent cycle characteristics whereby there is little deterioration of capacity even if charge and discharge are repeated.

Furthermore, since the electrode active material contains the organic compound as the main component, the environmental burden is low and the safety is taken into consideration.

The present invention is not limited to the above-mentioned embodiments, and various variations may be made without departing from the gist of the invention. For example, with respect to the organic compound predominantly constituting the positive electrode active material and the chain sulfone compound, each of the compounds listed above is just an example of these compounds, and the compound is not limited to these compounds. That is, when the electrode active material contains the organic compound described above as the main component and the chain sulfone compound is contained in the electrolyte, it is thought that a desired quick oxidation-reduction reaction proceeds, and therefore a secondary battery having high energy density and excellent stability can be obtained.

Further, the organic compound may be used for the negative electrode active material, while the organic compound is used for the positive electrode active material in the above-mentioned embodiment.

In the above-embodiment, the coin type secondary battery has been described, and furthermore, it is needless to say that a shape of the battery is not particularly limited, and the present invention can also be applied to a cylindrical battery, a prismatic battery, a sheet-shaped battery, and the like. Also, a casing method is not also particularly limited, and a metal case, a molded resin, an aluminum laminate film or the like may be used.

### EXAMPLES

Next, Examples of the present invention will be specifically described.

Besides, each of Examples shown below is just an example, and the present invention is not limited to Examples below.

### Example 1

### Preparation of Battery

As a material for an active material, a rubeanic acid represented by the chemical formula (2a) was prepared, and as a solvent of an electrolyte, ethyl isopropyl sulfone represented by the chemical formula (1e) was prepared.

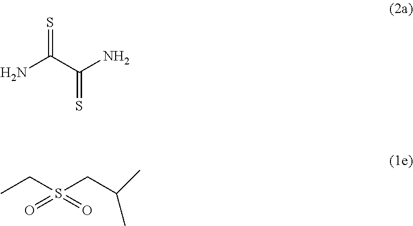

Then, 300 mg of the rubeanic acid, 600 mg of graphite powder as a conductive agent, and 100 mg of a polytetrafluoroethylene resin as a binder were respectively weighed, and these weighed materials were kneaded while being uniformly mixed as a whole.

Subsequently, the resulting mixture was pressure-formed to prepare a sheet-shaped member having a thickness of approx. 150 μm. Thereafter, the sheet-shaped member was dried at 70° C. for one hour in vacuum, and then punched out into a round shape with a diameter of 12 mm to prepare a positive electrode active material containing the rubeanic acid as the main component.

Next, the positive electrode active material was applied onto a positive electrode current collector, and further a separator having a thickness of 20 μm, which was made of a polypropylene porous film impregnated with the electrolyte solution described later, was laminated on the positive electrode active material, and further a negative electrode obtained by attaching lithium to a negative electrode current collector made of a copper foil was laminated on the separator to forma laminate.

Then, LiN(C₂F₅SO₂)₂ (electrolyte salt) having a mole concentration of 1.0 mol/L was dissolved in ethyl isopropyl sulfone to prepare an electrolyte solution.

Subsequently, 0.2 mL of the electrolyte solution was added dropwise to the laminate to allow the electrolyte solution to penetrate into the laminate.

Thereafter, a metallic spring was placed on the negative electrode current collector, and a negative electrode case was joined to a positive electrode case with a gasket arranged at a periphery, and these cases were externally sealed with a caulking machine. Thereby, a hermetically sealed coin type secondary battery was prepared in which the positive electrode active material contained a rubeanic acid as the main component, the negative electrode active material was formed of metal lithium, and the electrolyte solution was formed of LiN(C₂F₅SO₂)₂ and ethyl isopropyl sulfone.

Check of Operation of Battery

The coin type battery thus prepared was charged at a constant current of 0.1 mA until a voltage reached 4.0 V, and thereafter, was discharged at a constant current of 0.1 mA until a voltage reached 1.5 V. Consequently, the battery was verified to be a secondary battery having a discharge capacity of 0.6 mAh, which had two plateaus at a charge-discharge voltage of 2.4 V and at a charge-discharge voltage of 2.0 V.

Then, a cycle of charge and discharge was repeated 20 times in a range of 4.0 to 1.5 V. Consequently, the secondary battery was found to be capable of ensuring 90% or more of the initial capacity. That is, a long-life secondary battery, which has excellent stability in which the deterioration of capacity is suppressed even if charge and discharge are repeated, could be attained. The reason for this is likely that the positive electrode active material was stabilized in the electrolyte solution and therefore charge and discharge of a multi-electron reaction could be stably repeated.

### Example 2

### Preparation of Battery

Four kinds of coin type batteries were prepared in the same manner/procedure as in Example 1 except for using, as a solvent for an electrolyte, each of chain sulfone compounds of dimethyl sulfone, ethyl methyl sulfone, methyl isopropyl sulfone and ethyl butyl sulfone instead of ethyl isopropyl sulfone.

Check of Operation of Battery

The batteries thus prepared were discharged in the same conditions as in Example 1, and their operation were checked, and consequently it was verified that the four kinds of batteries were all secondary batteries each having a discharge capacity of 0.6 mAh, which had two plateaus at a charge-discharge voltage of 2.3 V and at a charge-discharge voltage of 2.0 V.

Thereafter, a cycle of charge and discharge was repeated 20 times in a range of 4.0 to 1.5 V. Consequently, all of four kinds of the batteries could ensure 80% or more of the initial capacity. That is, the positive electrode active material was stabilized in the electrolyte solution, and therefore charge and discharge of a multi-electron reaction could be stably repeated, and a long cycle-life secondary battery in which the deterioration of capacity is suppressed even if charge and discharge are repeated, could be obtained.

### Example 3

### Synthesis of Organic Compound

A condensate (2d) of rubeanic acid and adipic acid dichloride was synthesized according to a synthesis scheme (A).

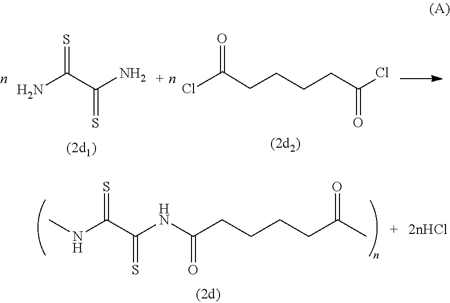

First, 0.01 mol of a rubeanic acid (2d₁) was dissolved in an aqueous solution of sodium hydroxide (mole concentration of sodium hydroxide: 0.02 mol). Then, after resulting solution was cooled to 0° C., an aqueous solution containing 0.1 mol of adipic acid dichloride (2d₂) was added dropwise while stirring the solution with intensity. The resulting mixture was stirred for one hour to allow the rubeanic acid (2d₁) to react with the adipic acid dichloride (2d₂), washed and dried to synthesize a light brown solid, i.e. condensate (2d) of the rubeanic acid and the adipic acid dichloride.

Preparation of Battery

A coin type battery of Example 3 was prepared in the same manner/procedure as in Example 1 except for using the above-mentioned condensate (2d) for a positive electrode active material.

Check of Operation of Battery

The battery thus prepared was discharged in the same conditions as in Example 1, and its operation was checked, and consequently it was verified that the battery was a secondary battery having a discharge capacity of 0.50 mAh, which had two plateaus at a charge-discharge voltage of 2.4 V and at a charge-discharge voltage of 2.0 V.

Thereafter, a cycle of charge and discharge was repeated 20 times in a range of 4.0 to 2.0 V, and consequently the secondary battery could ensure 80% or more of the initial capacity even after 20 cycles. That is, the positive electrode active material was stabilized in the electrolyte solution, and therefore charge and discharge of a multi-electron reaction could be stably repeated, and a secondary battery, which has excellent stability in which the deterioration of capacity is suppressed even if charge and discharge are repeated, could be attained.

### Example 4

### Synthesis of Organic Compound

A condensate of rubeanic acid and terephthalic acid dichloride was synthesized according to a synthesis scheme (B). A condensate (2e) of rubeanic acid and adipic acid dichloride was synthesized.

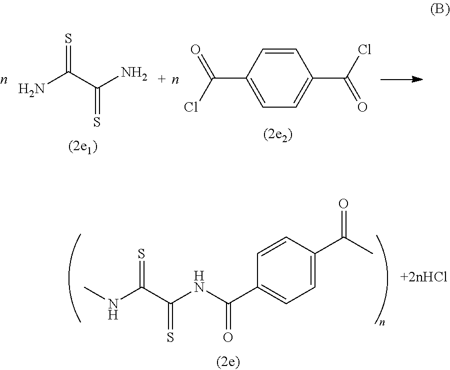

First, 0.01 mol of a rubeanic acid (2e₁) was dissolved in an aqueous solution of sodium hydroxide (mole concentration of sodium hydroxide: 0.02 mol). Then, after the resulting solution was cooled to 0° C., an aqueous solution containing 0.1 mol of terephthalic acid dichloride (2e₂) was added dropwise while stirring the solution with intensity. The resulting mixture was stirred for one hour to allow the rubeanic acid (2e₁) to react with the terephthalic acid dichloride (2e₂), washed and dried to synthesize a light brown solid, or condensate (2e) of the rubeanic acid and the terephthalic acid dichloride.

Preparation of Battery

A coin type battery of Example 4 was prepared in the same manner/procedure as in Example 1 except for using the above-mentioned condensate (2e) for a positive electrode active material.

Check of Operation of Battery

The battery thus prepared was discharged in the same conditions as in Example 1, and its operation was checked, and consequently it was verified that the battery was a secondary battery having a discharge capacity of 0.20 mAh, which had two plateaus at a charge-discharge voltage of 2.4 V and at a charge-discharge voltage of 2.0 V.

Thereafter, a cycle of charge and discharge was repeated 10 times in a range of 4.0 to 2.0 V, and consequently the secondary battery could ensure 80% or more of the initial capacity even after 10 cycles. That is, the positive electrode active material was stabilized in the electrolyte solution, and therefore charge and discharge of a multi-electron reaction could be stably repeated, and a secondary battery, which has excellent stability in which the deterioration of capacity is suppressed even if charge and discharge are repeated, could be attained.

### Example 5

### Preparation of Battery

A coin type battery of Example 4 was prepared in the same manner/procedure as in Example 1 except for using thiocarbamoyl thiourea represented by the chemical formula (3a) as a positive electrode active material.

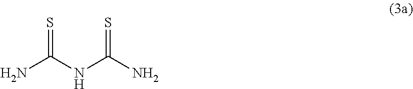

Check of Operation of Battery

The battery thus prepared was discharged in the same conditions as in Example 1, and its operation was checked, and consequently it was verified that the battery was a secondary battery having a discharge capacity of 0.2 mAh, which had a plateau at a charge-discharge voltage of 2.0 to 2.8 V.

Thereafter, a cycle of charge and discharge was repeated 10 times in a range of 4.0 to 2.0 V, and consequently the secondary battery could ensure 80% or more of the initial capacity even after 10 cycles. That is, the positive electrode active material was stabilized in the electrolyte solution, and therefore charge and discharge of a multi-electron reaction could be stably repeated, and a secondary battery, which has excellent stability in which the deterioration of capacity is suppressed even if charge and discharge are repeated, could be attained.

### Example 6

### Synthesis of Organic Compound

A condensate (5d) of selenourea and succinyl chloride was synthesized according to a synthesis scheme (C).

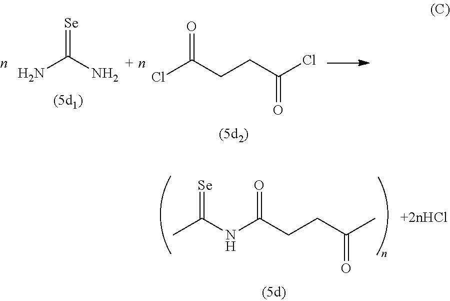

First, 0.62 g of selenourea (5d₂) was dissolved in 50 mL of pure water. Then, the whole resulting solution was cooled to 0° C., and to this, an aqueous solution containing 0.77 g of succinyl chloride (5d₂) was added dropwise while stirring the solution with intensity. The resulting mixture was stirred for one hour to allow the selenourea (5d₂) to react with the succinyl chloride (5d₂), washed and dried to synthesize a light brown solid, or condensate (5d) of the selenourea and the succinyl chloride.

Preparation of Battery

A coin type battery of Example 6 was prepared in the same manner/procedure as in Example 1 except for using the above-mentioned condensate (5d) for a positive electrode active material.

Check of Operation of Battery

The battery thus prepared was discharged in the same conditions as in Example 1, and its operation was checked, and consequently it was verified that the battery was a secondary battery having a discharge capacity of 0.2 mAh, which had a plateau at a charge-discharge voltage of 1.5 to 3.2 V.

Then, a cycle of charge and discharge was repeated 10 times in a range of 4.0 to 2.0 V, and consequently the secondary battery could ensure 80% or more of the initial capacity even after 10 cycles. That is, the positive electrode active material was stabilized in the electrolyte solution, and therefore charge and discharge of a multi-electron reaction could be stably repeated, and a secondary battery, which has excellent stability in which the deterioration of capacity is suppressed even if charge and discharge are repeated, could be attained.

### Example 7

### Preparation of Battery

A coin type battery was prepared in the same manner as in Example 1 except for using poly(2,2,6,6-tetramethylpiperidinoxy methacrylate) indicated by the chemical formula (7c) for a positive electrode active material.

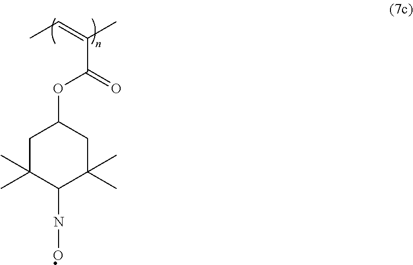

Check of Operation of Battery

The battery thus prepared was discharged in the same conditions as in Example 1, and its operation was checked, and consequently it was verified that the battery was a secondary battery having a discharge capacity of 0.11 mAh, which had a plateau at a charge-discharge voltage of 3.6 V.

Thereafter, a cycle of charge and discharge was repeated 100 times in a range of 4.0 to 2.0 V, and consequently the secondary battery could ensure 90% or more of the initial capacity even after 100 cycles. That is, the positive electrode active material was stabilized in the electrolyte solution and the movement of ions in a charge and discharge reaction became easy, and therefore the charge-discharge reaction proceeded smoothly and it was possible to perform charging in a short time and discharging at high output. Accordingly, a long cycle-life secondary battery, which has excellent stability in which the deterioration of capacity is suppressed even if charge and discharge are repeated, could be attained.

### Example 8

### Synthesis of Organic Compound

A polymer (8f) of a dihydrophenazine dicarbonyl compound was synthesized according to a synthesis scheme (D).

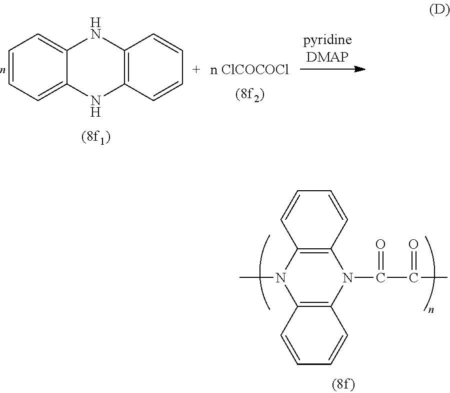

First, 8.2 mmol of 5,10-dihydrophenazine (8f₁) and 20 mg of 4-dimethylaminopyridine (DMAP) were dissolved in 20 mL of dehydrated pyridine in an argon flow, and then to this, a mixed solution of 5 mL of dehydrated tetrahydrofuran and 8.2 mmol of oxalyl chloride was added at 0° C. Thereafter, the resulting mixture was stirred at room temperature for one hour, and further stirred at 60° C. for 4 hours to allow 5,10-dihydrophenazine (8f₁) to react with oxalyl chloride (8f₂). After the completion of the reaction, dehydrated pyridine was removed, and thereafter methanol was added, precipitated black powder was filtrated, and thereby a polymer (8f) of a dihydrophenazine dicarbonyl compound was obtained.

Preparation of Battery

A coin type battery of Example 8 was prepared in the same manner/procedure as in Example 1 except for using the above-mentioned polymer (8f) for a positive electrode active material.

Check of Operation of Battery

The battery thus prepared was discharged in the same conditions as in Example 1, and its operation was checked, and consequently it was verified that the battery was a secondary battery having a discharge capacity of 0.21 mAh, which had two plateaus at a charge-discharge voltage of 2.8 V and at a charge-discharge voltage of 2.4 V.

Then, a cycle of charge and discharge was repeated 100 times in a range of 4.0 to 2.0 V, and consequently the secondary battery could ensure 90% or more of the initial capacity even after 100 cycles. That is, the positive electrode active material was stabilized in the electrolyte solution, and therefore charge and discharge of a multi-electron reaction could be stably repeated, and a secondary battery, which has excellent stability in which the deterioration of capacity is suppressed even if charge and discharge are repeated, could be attained.

A secondary battery, which has high energy density, high output, and excellent and stable cycle characteristics in which the deterioration of capacity is suppressed even if charge and discharge are repeated, is realized.

### REFERENCE SIGNS LIST

4 Positive electrode
6 Negative electrode
9 Electrolyte solution (electrolyte)

1. A secondary battery comprising:
an electrode active material; and
an electrolyte,
wherein the electrode active material has, as a main component thereof, an organic compound containing in its structural unit at least one compound selected from the group consisting of a dithione compound having a dithione structure, a dione compound having a dione structure, an organic radical compound containing a stable radical group, and a diamine compound having a diamine structure, and
the electrolyte contains a chain sulfone compound.

2. The secondary battery according to claim 1, wherein the chain sulfone compound is represented by: 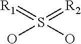
wherein R₁ and R₂ contain at least one selected from the group consisting of a linear alkyl group and a branched alkyl group respectively having 1 to 5 carbon atoms.

3. The secondary battery according to claim 1, wherein the dithione compound is represented by: 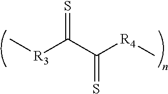
wherein n is an integer of 1 or more, R₃ and R₄ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof.

4. The secondary battery according to claim 3, wherein R₃ and R₄ are the same.

5. The secondary battery according to claim 3, wherein R₃ and R₄ are linked together to form a saturated or unsaturated ring.

6. The secondary battery according to claim 1, wherein the dithione compound is represented by: 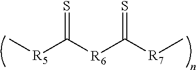
wherein n is an integer of 1 or more, R₅ and R₇ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof and R₆ is at least one of a substituted or unsubstituted alkylene group and a substituted or unsubstituted arylene group.

7. The secondary battery according to claim 6, wherein R₅ and R₇ are the same.

8. The secondary battery according to claim 6, wherein R₅ and R₇ are linked together to form a saturated or unsaturated ring.

9. The secondary battery according to claim 1, wherein the dione compound is represented by: 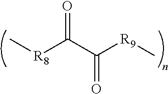
wherein n is an integer of 1 or more, R₈ and R₉ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof.

10. The secondary battery according to claim 9, wherein R₈ and R₉ are the same.

11. The secondary battery according to claim 9, wherein R₈ and R₉ are linked together to form a saturated or unsaturated ring.

12. The secondary battery according to claim 1, wherein the dione compound is represented by: 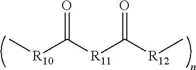
wherein n is an integer of 1 or more, R₁₀ and R₁₂ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and R₁₁ indicates at least one of a substituted or unsubstituted alkylene group and a substituted or unsubstituted arylene group.

13. The secondary battery according to claim 12, wherein R₁₀ and R₁₂ are the same.

14. The secondary battery according to claim 12, wherein R₁₀ and R₁₂ are linked together to form a saturated or unsaturated ring.

15. The secondary battery according to claim 1, wherein the organic radical compound is a nitroxyl radical-based compound.

16. The secondary battery according to claim 15, wherein the nitroxyl radical-based compound contains 2,2,6,6-tetramethylpiperidine-N-oxyl radical in the molecular structure thereof.

17. The secondary battery according to claim 1, wherein the diamine compound is represented by: 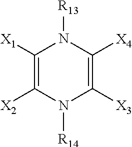
wherein R₁₃ and R₁₄ are any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof; and X₁ to X₄ indicate at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group, and a substituted or unsubstituted acyloxy group.

18. The secondary battery according to claim 17, wherein R₁₃ and R₁₄ form a cyclic structure therebetween.

19. The secondary battery according to claim 1, wherein the electrode active material is contained in any one of a reaction starting material, a reaction product and an intermediate product in at least a discharge reaction of an electrode reaction in the secondary battery.

20. The secondary battery according to claim 1, wherein the secondary battery has a positive electrode and a negative electrode, and the positive electrode comprises the electrode active material as a main component thereof.
